(19) United States
(12) Patent Application Publication
(10) Pub. No.: US 2018/0094787 A1
(43) Pub. Date: Apr. 5, 2018

(54) VEHICLE LIGHTING FIXTURE

(71) Applicant: ICHIKOH INDUSTRIES, LTD., Isehara-shi, Kanagawa-ken (JP)

(72) Inventor: Toshiya ABE, Isehara-shi, Kanagawa-ken (JP)

(73) Assignee: ICHIKOH INDUSTRIES, LTD., Isehara-shi, Kanagawa-ken (JP)

(21) Appl. No.: 15/562,512

(22) PCT Filed: Apr. 1, 2016
(86) PCT No.: PCT/JP2016/060952

§ 371 Date: Sep. 28, 2017

(30) Foreign Application Priority Data
Apr. 2, 2015 (JP) 2015-076269

(51) Int. Cl. F21S 41/19; F21S 41/32; F21S 41/50; F21S 8/02

(52) U.S. Cl. CPC F21S 41/192; F21S 8/028; F21S 41/50; F21S 41/32

(57) ABSTRACT

A present invention is provided with a semiconductor-type light source, a bracket, a rotating shaft, a movable shade, a solenoid, and a connecting member. The movable shade is configured from a steel plate. The movable shade is provided with mounting pieces. The mounting pieces are provided with through holes. A crushed surface is formed on an edge section at the side opposite to an edge section of the side of a burr of each of the through holes. Consequently, the present invention provides a vehicle lighting fixture by which smooth switching of light distribution can be achieved by preventing damage to the surface of the rotating shaft over a long time.

### TECHNICAL FIELD

The present invention relates to a vehicle lighting fixture which is capable of switching light distribution

### BACKGROUND ART

Conventionally, a vehicle lighting fixture of such a type is known (for example, Patent Literature 1) Hereinafter, a conventional vehicle will be described

The conventional vehicle lighting fixture is equipped with: a light source; a reflector; a projection lens; a lens holder; a movable shade; and a light distribution switching actuator The movable shade is formed by pressing a metal plate At the movable shade, a pair of supporting pieces are formed At the pair of supporting pieces, shaft holes are respectively provided A shaft member which has been provided at the lens holder is inserted into a respective one of the shaft holes In this manner, the movable shade is rotatably mounted to the lens holder via the shaft member To the movable shade and the light distribution switching actuator, connecting rods are respectively connected According to turning on or off the power of the light distribution switching actuator, the movable shade is rotated, and it is possible to obtain a low beam light distribution and a high beam light distribution so as to be switchable to each other

### CITATION LIST

### Patent Literature

Patent Literature 1: Japanese Unexamined Patent Application Publication No 2011-258485

### SUMMARY OF THE INVENTION

### Problems to be Solved by the Invention

However, in the conventional vehicle lighting fixture of the Patent Literature, when the movable shade has been formed by pressing the metal plate, a burring arises at an edge of a supporting piece of the movable shade Thus, in the conventional vehicle lighting fixture of the Patent Literature mentioned above, there may be a case in which a surface of the shaft member is damaged with an elapse of time owing to the burring at the edge of the shaft hole of the supporting piece of the movable shade, and in this case, there may be a case in which smooth switching of light distribution cannot be achieved

A problem to be solved by the present invention is to provide a vehicle lighting fixture which is capable of achieving smooth switching of light distribution while preventing damage to the surface of a rotating shaft (a shaft member) over a long period of time

### Means for Solving the Problem

In the present invention according to a first aspect, a vehicle lighting fixture comprising a light source and an optical control device for light distribution, which optically controls light from the light source to a predetermined light distribution, wherein the optical control device for light distribution has: a bracket; a movable, optical controlling member for light distribution, which is mounted to the bracket so as to be rotatable via a rotating shaft; and a driving mechanism to rotate the movable, optical controlling member for light distribution, the movable, optical controlling member for light distribution is composed of a plate material, at the movable, optical controlling member for light distribution, a mounting member is provided, at the mounting piece, a through hole into which the rotating shaft is to be inserted is provided, and at least at an edge section of the through hole, a crushed surface, which is crushed at the mounting piece side from an inner circumferential face of the through hole, is formed

In the present invention according to a second aspect, the movable, optical controlling member for light distribution is movable along the rotating shaft with respect to the rotating shaft, the mounting piece of the movable, optical control members for light distribution is orthogonal to or substantially orthogonal to a direction of a central axis thereof, and at the bracket, a stopper to abut against the mounting piece to thereby stop movement in the direction of the central axis of the movable, optical controlling member for light distribution is provided

In the present invention according to a third aspect, a vehicle lighting fixture comprising a light source and an optical control device for light distribution, which optically controls light from the light source to a predetermined light distribution, wherein the optical control device for light distribution has: a bracket; a movable, optical controlling member for light distribution, which is mounted to the bracket so as to be rotatable via a rotating shaft; and a driving mechanism to rotate the movable, optical controlling member for light distribution, the movable, optical controlling member for light distribution is composed of a plate material; at the movable, optical controlling member for light distribution, a mounting member is provided, and in the mounting piece, a through hole into which the rotating shaft is to be inserted is provided by burring processing

In the present invention according to a fourth aspect, at one edge of the through hole, a cylindrical flange is formed by the burring processing, and at the flange, a pressed surface on which opening of the flange is pressed from an inner circumferential face of the flange to an outside is formed

In the present invention according to a fifth and sixth aspects, he movable, optical controlling member for light distribution is movable with respect to the rotating shaft, in the direction of the central axis of the rotating shaft, the mounting piece of the movable, optical controlling member for light distribution is orthogonal to or substantially orthogonal to the direction of the central axis, and at the bracket, a stopper to abut against the mounting piece to thereby stop movement in the direction of the central axis of the movable, optical controlling member for light distribution is provided

### Effect of the Invention

A vehicle lighting fixture of the present invention (the invention according to claim 1) is characterized in that a crushed surface is formed at least at one of edge sections of through holes of mounting pieces of a movable, optical controlling member for light distribution, which is composed of a plate material so as to be thus able to eliminate the burring that arises at the edge of the through hole of the mounting piece of the movable, optical controlling member for light distribution Therefore, in so far as the vehicle lighting fixture of the present invention (the invention according to claim 1) is concerned, the surface of the rotating shaft is not damaged owing to the burring over a long period of time; and hence, it is possible to achieve smooth switching of light distribution

A vehicle lighting fixture of the present invention (the invention according to claim 3) is characterized in that the through holes of the mounting pieces of the movable, optical controlling member for light distribution, that is composed of the plate material are provided by burring processing, and thus, the surface of the plate material can be obtained as an inner circumferential face of the through hole as it is That is, the inner circumferential face of the through hole is not a rupture surface (a shear surface) exerted by pressing, but a smooth face of the surface of the plate member Therefore, in so far as the vehicle lighting fixture of the present invention (the invention according to claim 3) is concerned, the surface of the rotating shaft is not damaged by the rapture face over a long period of time; and hence it is possible to achieve smooth switching of light distribution

### BRIEF DESCRIPTION OF THE DRAWINGS

FIG. 1 is a schematic longitudinal cross section (a schematic vertical cross section) of a lamp unit showing a first embodiment of a vehicle lighting fixture according to the present invention

FIG. 2 is an explanatory view showing the processing steps of a movable shade

FIG. 3 is a partially enlarged explanatory cross section of the movable shade

FIG. 4 is an assembling perspective view showing an optical control device for light distribution

FIG. 5 is a dissembling perspective view showing the optical control device for light distribution

FIG. 6 is a front view showing the optical control device for light distribution

FIG. 7 is a sectional view taken along the line VII-VII in FIG. 6

FIG. 8 is a partially enlarged cross section

FIG. 9 is an explanatory view of the processing steps of the movable shade, showing a second embodiment of the vehicle lighting fixture according to the present invention

FIG. 10 is a partially enlarged explanatory cross section of the movable shade

### MODE FOR CARRYING OUT THE INVENTION

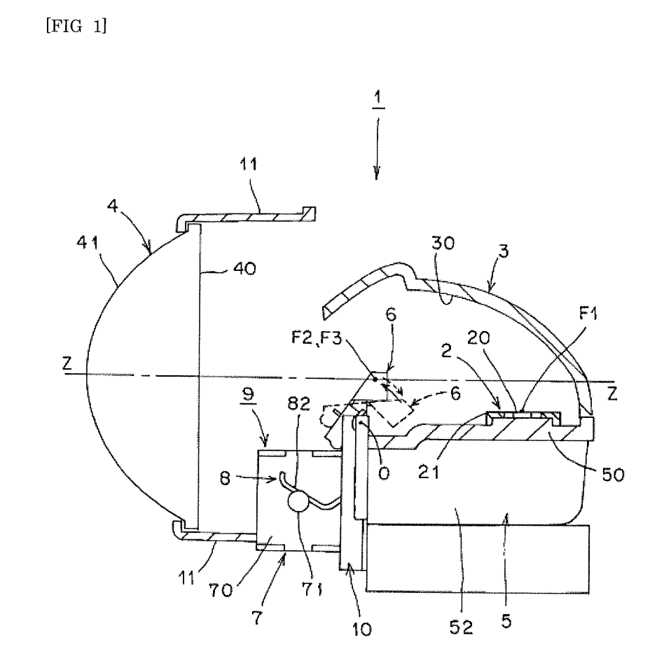

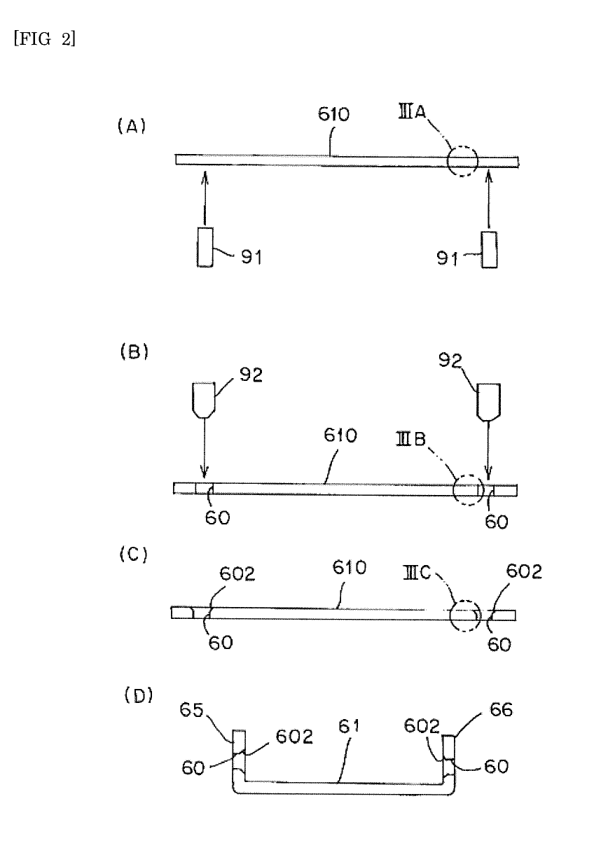

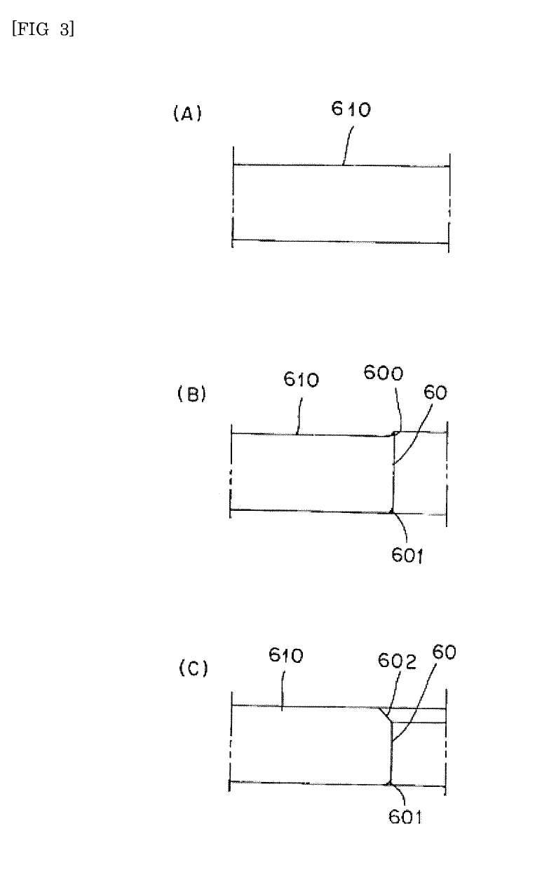

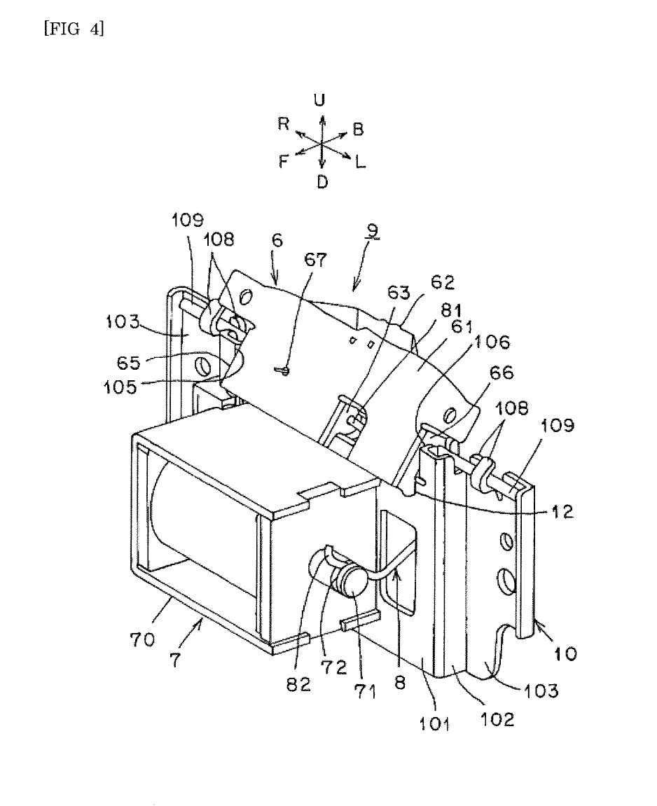

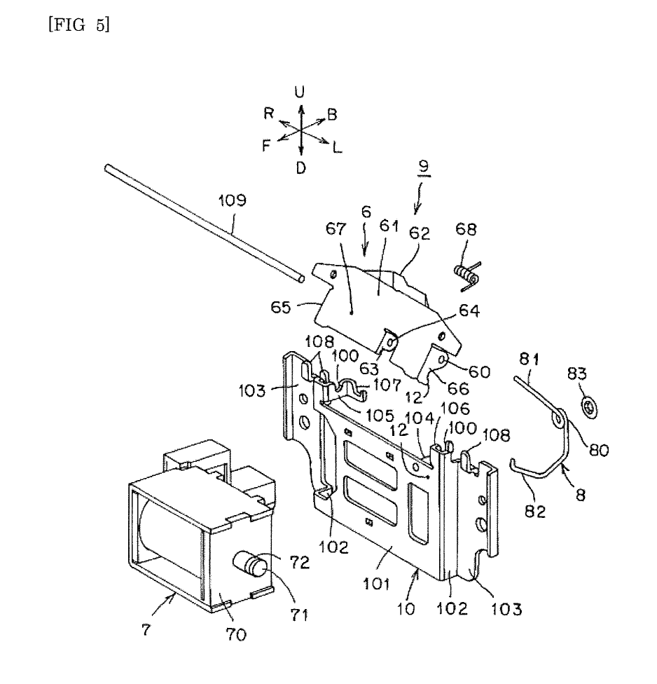

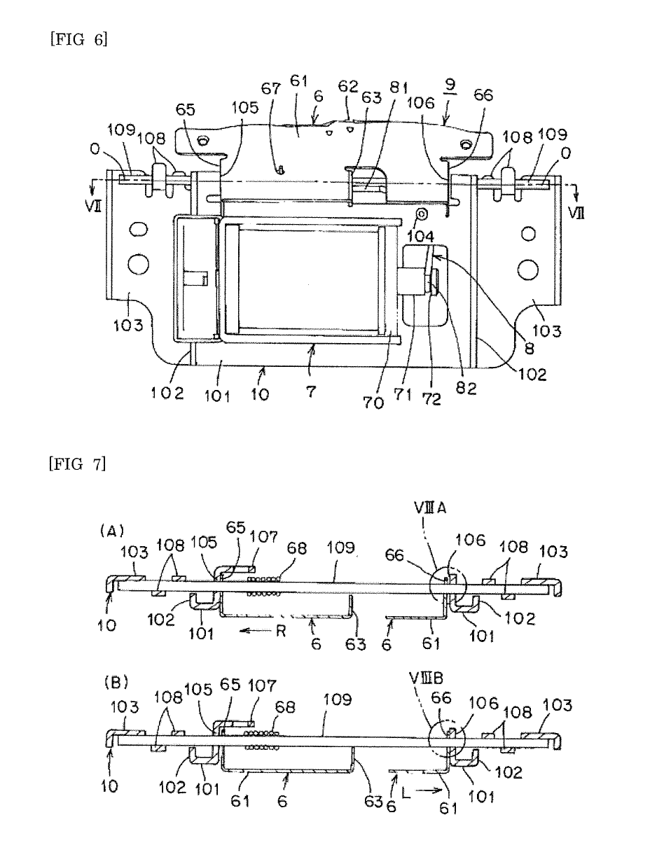

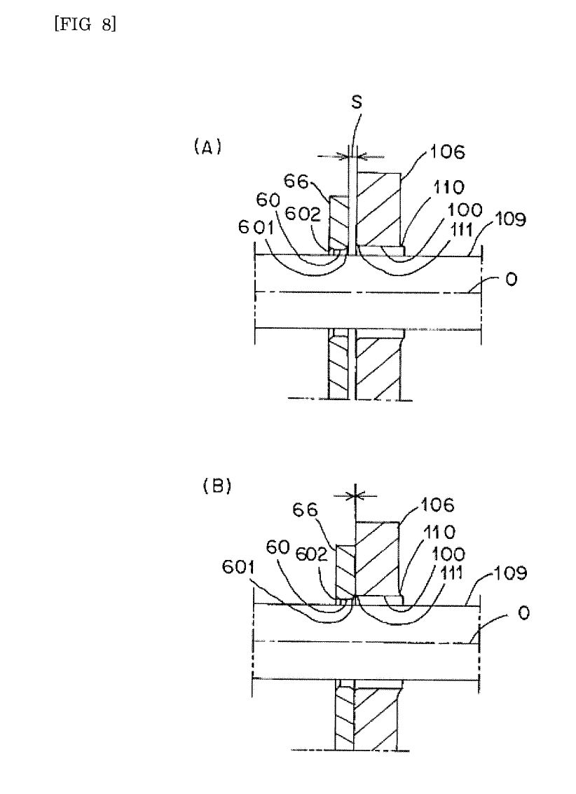

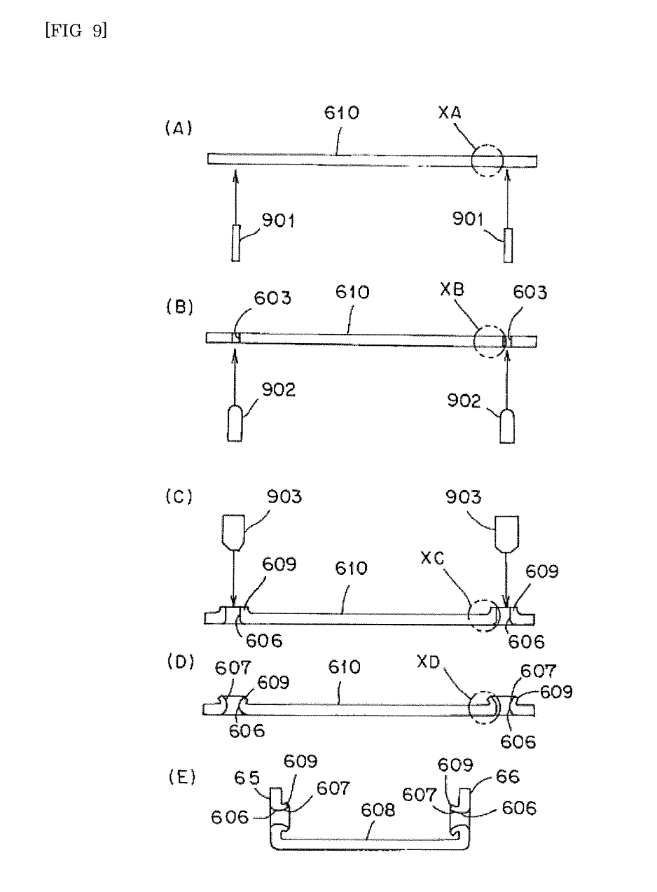

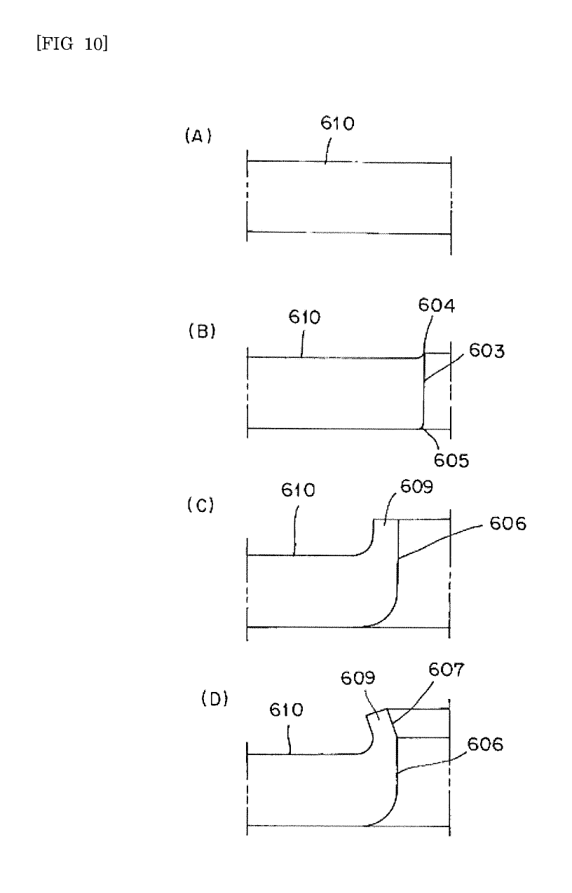

Hereinafter, two examples of embodiments of a vehicle lighting fixture according to the present invention will be described in detail Incidentally, the present invention is not limited by the embodiments In FIG. 1, hatching of a semiconductor-type light source, a projection lens, a bracket, a movable shade, a solenoid, and a connecting member is omitted In FIG. 2, FIG. 3, FIG. 9, and FIG. 10, hatching of the movable shade is omitted In FIG. 7 and FIG. 8, hatching of a rotating shaft is omitted In the present specification, the front, rear, top, bottom, left and right respectively refer to the front, rear, top, bottom, left and right, when the vehicle lighting fixture according to the present invention is mounted on a vehicle In FIG. 4 and FIG. 5, reference code “F” refers to the “front”, reference code “B” refers to the “rear”, reference code “U” refers to the “top”, reference code “D” refers to the “bottom”, reference code “L” refers to the “left”, and reference code “R” refers to the “right”

### Description of Configuration of First Embodiment

Hereinafter, a configuration of a vehicle lighting fixture in the first embodiment will be described In this example, for example, a headlamp as a vehicle headlamp will be described

(Description of Vehicle Lighting Fixture)

In FIG. 1, reference numeral 1 refers to the vehicle lighting fixture in the first embodiment The vehicle lighting fixture 1 is mounted to a respective one of the left and right sides of a front side of a vehicle The vehicle lighting fixture 1, as shown in FIG. 1, is provided with: a lamp housing (not shown); a lamp lens (not shown); a semiconductor-type light source 2 as a light source; a reflector 3; a projection lens 4; a head sink member 5; and an optical control device 9 for light distribution

An optical axis Z of the vehicle lighting fixture 1 (in this example, an optical axis of the projection lens 4) forms a longitudinal direction Thus, the optical axis Z is orthogonal to or substantially orthogonal to (perpendicular to or substantially perpendicular to) the transverse direction and the vertical direction

The optical control device 9 for light distribution has: a movable shade 6 as a movable, optical controlling member for light distribution; a solenoid 7 and a connecting member 8 as a driving mechanism, and a bracket 10 and a holder 11 as mounting members

The lamp housing and the lamp lens (such as a transparent outer lens, for example) partitions a lamp room (not shown) The semiconductor-type light source 2, the reflector 3, the projection lens 4, the heat sink member 5, and the optical control device 9 for light distribution (the movable shade 6, the solenoid 7, the connecting member 8, the bracket 10, and the holder 11) constitute a lamp unit of projector type The members 2, 3, 4, 5, 9 (6, 7, 8, 10, 11) that constitute the lamp unit are disposed in the lamp room, and are mounted to the lamp housing via the bracket 10, the holder 11, an optical axis adjustment mechanism for vertical direction (not shown) and an optical axis adjustment mechanism for transverse direction (not shown)

Incidentally, in the lamp room, there may be a case in which a certain lamp unit other than the members 2, 3, 4, 5, 9 (6, 7, 8, 10, 11) that constitute the lamp unit, for example, a clearance lamp unit, a turning lamp unit, a daytime running lamp unit or the like is disposed In addition, in the lamp room, there may be a case in which an inner panel (not shown), an inner housing (not shown), an inner lens (not shown) or the like is disposed

(Description of Bracket 10 and Holder 11)

The bracket 10 and the holder 11 form a separate structure or an integral structure There may be a case in which the mounting member is provided with a certain mounting section other than the bracket 10 and the holder 11

The bracket 10 forms a shape of a plate The bracket 10 is formed by pressing and bending a plate material, in this example, a steel plate The bracket 10 is composed of: a first plate section 101 at a front side of a center (middle); a second plate section 102 at each of the left and right sides; and a third plate section 103 at a rear side of each of the left and right sides

The first plate section 101 forms a shape of a transversely elongated rectangular plate The heat sink member 5 is disposed on a face of a rear side of the first plate section 101 (at the semiconductor-type light source 2 side and at an opposite side of the projection lens 4) The solenoid 7 is mounted on a face of a front side of the first plate section 101 (at an opposite side of the semiconductor-type light source 2 and at the projection lens 4 side) In the first plate section 101, an opening section, a through hole, and a cutout or the like for mounting the solenoid 7 are provided

At a left side of the rear side face of the first plate section 101, one end of a mounting shaft 101 which forms a columnar shape, in this example, is fixed The mounting shaft 104 is disposed to be parallel to or substantially parallel to the optical axis Z To the mounting shaft 104, a mounting section 80 of the connecting member 8 is mounted via a stop ring 83

At the left and right of an upper end of the first plate section 101, a first stopper 105 and a second stopper 106 are respectively provided to be integral with each other while these stoppers are bent at a right angle or substantially at a right angle to a rear side from the first plate section 101 The first stopper 105 and the second stopper 106 are parallel to or substantially parallel to the optical axis Z, and oppose to each other in the transverse direction The first stopper 105 is intended to stop movement in the right side axis direction of the movable shade 6 (refer to the arrow R in FIG. 7(A)) The second stopper 106 is intended to stop movement in the left side axis direction of the movable shade 6 (refer to the arrow L in FIG. 7(B))

At the first stopper 105, an engagement piece 107 is integrally provided while the engagement piece is bent at a right angle or substantially at a right angle to a left side from the first stopper 105 At a center of an upper end of the engagement piece 107, an engagement recessed section is provided At centers of upper ends of the first stopper 105 and the second stopper 106, recessed sections 100 are respectively provided At the recessed section 100 of the first stopper 105 and the recessed section 100 of the second stopper 106, rotating shafts 109 are respectively provided As shown in FIG. 8, at one edge of the recessed section 100, a burring 110 is formed At the other edge of the recessed section 100, a droop 111 is formed

The left and right second plate sections 102 are respectively provided to be integral with each other while these plate sections are bent at a right angle or substantially at a right angle to a rear side from both of the left and right sides of the first plate section 101 At rear sides of upper ends of the left and right second plate sections 102, cutouts are respectively provided In the cutouts, the rotating shafts 109 are respectively provided

The left and right third plate sections 103 are respectively provided to be integral with each other while these plate sections are bent at a right angle or substantially at a right angle to both of the left and right sides from the rear sides of the left and right second plate sections 102 At upper ends of the third left and right plate sections 103, swaging pieces 108 are respectively integrally provided At the swaging piece 108, the rotating shaft 109 is swaged and fixed A central axis O of the rotating shaft 109 (hereinafter, simply referred to as the “central axis O”) is parallel to or substantially parallel to the transverse direction, and is orthogonal to or substantially orthogonal to the optical axis Z in the longitudinal direction

To the rotating shaft 109, the movable shade 6 is mounted to be rotatable in the longitudinal direction (refer to the solid arrow and dashed arrow in FIG. 1) about the central axis O The movable shade 6 is movable with respect to the rotating shaft 109, in the direction of the central axis O (refer to the arrow R in FIG. 7(A) and the arrow L in FIG. 7(B)), that is, along the rotating shaft 109 The rotating shaft 109, in this example, is composed of a stainless steel

In the third plate section 103, a positioning hole and a mounting hole or the like are provided At the third plate section 103, the heat sink member 5 is positioned and mounted by positioning means (not shown) or screw (not shown) The third plate section 103 is mounted to the lamp housing via the optical axis adjustment mechanism for vertical direction and the optical axis adjustment mechanism for transverse direction (and the mounting section)

The holder 11 forms a shape of a ring The projection lens 4 is mounted to the holder 11

(Description of Semiconductor-Type Light Source 2)

The semiconductor-type light source 2 is a self-emission, semiconductor-type light source such as an LED, an OEL, or an OLED, for example The semiconductor-type light source 2 has a light emitting section 20 to radiate light (not shown) The light emitting section 20 has a rectangular light emission surface of which longitudinal direction crosses (in this example, is orthogonal to or substantially orthogonal to) the optical axis Z in the transverse direction The light emitting section 20 is oriented upward in this example

The semiconductor-type light source 2 is implemented on the heat sink member 5, and is mounted to the heat sink member 5 via the holder 21 the holder 21 is mounted to the heat sink member 5 by way of screw or the like (not shown) To the semiconductor-type light source 2, a current from a lighting circuit (not shown) is supplied

(Description of Reflector 3)

The reflector 3 is made of a highly thermally resistive and optically non-transmissible material such as a resin member, for example This reflector 3 is mounted to the heat sink member 5 by way of screw (not shown)

The reflector 3 forms a hollow shape which is open at the front side section and the lower side section, and which are closed at the rear side section, the upper side section, and the left and right side sections On a recessed interior face of the closed sections of the reflector 3, a reflection surface (a divergent reflection surface) 30 made of a free curved surface or a rotating elliptical surface on the basis of an elliptical shape (on the basis of a rotating elliptical surface) is provided The reflection surface 30 has: a first focal point F1 which is positioned at or near a center of the light emitting section 20 of the semiconductor-type light source 2; a second focal point (a second focal line) F2; and an optical axis (not shown) to connect the first focal point F1 and the second focal point F2 to each other The reflection surface 30 is intended to reflect light to the projection lens 4 side while the light from the light emission surface of the light emitting section 20 oriented upward of the semiconductor-type light source 2 is employed as reflection light (not shown)

(Description of Projection Lens 4)

The projection lens 4 is made of a resin-based lens such as a PC material, a PMMA material, or a PCO material, for example That is, the light radiated from the light emitting section 20 of the semiconductor-type light source 2 does not have a high temperature heat and thus a resin-based lens can be used as the projection lens 4 The projection lens 4 is mounted to the holder 11

The projection lens 4 has a focal point F3 (a focal line, a lens focal point, a lens focal line, or a meridional image which is a focal face on a material space side) and the optical axis Z The focal point F3 of the projection lens 4 is positioned at or near the second focal point F2 of the reflection surface 30 The optical axis Z of the projection lens 4 and the optical axis of the reflection surface 30 cross each other at or near the second focal point F2 and the third focal point F3 Incidentally, there may also be a case in which the optical axis Z of the projection lens 4 and the optical axis of the reflection surface 30 are coincident with or substantially coincident with each other

The projection lens 4 is a projection lens on the basis of a non-spherical face The projection lens 4 is composed of an incidence surface 40 as a rear face and an emission surface 41 as a front face The incidence surface 40 opposes to the reflector 3 The incidence surface 40 forms a plane or a non-spherical, substantial plane (a convex face or a concave face with respect to the reflector 3) The emission surface 41 forms a non-spherical surface

The projection lens 4 radiates to the outside, that is, to a front side of the vehicle, as predetermined light distribution patterns (not shown), the light from the light emitting section 20 of the semiconductor-type light source 2, the reflection light from the reflection surface 30 of the reflector 3 The predetermined light distribution patterns, in this example, are a low beam light distribution pattern (not shown) and a high beam light distribution pattern (not shown)

(Description of Heat Sink Member 5)

The heat sink member 5 is made of a material with a high thermal conductivity such as a resin or a metallic die-cast (an aluminum die-cast), for example The heat sink member 5 is composed of a top plate section 50 and a plurality of fin sections 52 The semiconductor-type light source 2 and the reflector 3 are mounted to the top plate section 50 The heat sink member 5 is mounted to the bracket 10 The heat sink member 5 may be made compatible with a heat radiation member and a mounting member

(Description of Movable Shade 6)

The movable shade 6 is composed of a plate material for an optically non-transmissible member, in this example, a stainless steel plate The movable shade 6 is formed by pressing and bending the stainless steel plate The movable shade 6 is composed of a first front side shade 61 and a second rear side shade 62 The first shade 61 and the second shade 62 are fixed to be integral with each other by way of swaging, fastening with rivet, and welding or the like subsequent to the above pressing and bending At upper edges of the first shade 61 and the second shade 62, edges to form a cutoff line (not shown) of the low beam light distribution pattern are respectively provided

At the right and left of a lower end part of the first shade 61, a first mounting piece 65 and a second mounting piece 66 are respectively provided to be integral with each other while these mounting pieces are bend at a right angle or substantially at a right angle to a rear side from the first shade 61 The first mounting piece 65 and the second mounting piece 66 are parallel to or substantially parallel to the optical axis Z and are orthogonal to or substantially orthogonal to the central axis O and further oppose to each other in the transverse direction

In the first mounting piece 65 and the second mounting piece 66, circular through holes 60 are respectively provided The rotating shaft 109 is inserted into the through hole 60 As a result, the movable shade 6 is mounted to the bracket 10 via the rotating shaft 109 so as to be rotatable about the central axis O (in the longitudinal direction) and to be movable in the direction of the central axis O (in the transverse direction)

The first mounting piece 65 opposes to a face at the droop 111 side of the first stopper 105 The first mounting piece 65 abuts against the first stopper 105, and as shown in FIG. 7(A), movement in the right side axis direction of the movable shade 6 is thereby stopped The second mounting piece 66 opposes to a face at the droop 111 side of the second stopper 106 The second mounting piece 66 abuts against the second stopper 106, and as shown in FIG. 7(B), movement in the left side axis direction of the movable shade 6 is thereby stopped

At the movable shade 6 and the bracket 10, rotation stoppers to stop rotation about the central axis O of the movable shade 7 are respectively provided The rotation stopper has a front side stopper 12 and a rear side stopper (not shown) The front side stopper 12 stops rotation in the front side direction of the movable shade 6 (the direction indicated by the solid line in FIG. 1) The rear side stopper stops rotation in the rear side direction of the movable shade 6 (the direction indicated by the dashed line in FIG. 1)

The movable shade 6 is positioned in a first position and a second position by way of: the front side stopper 12 and the rear side stopper of the rotation stopper; and the first mounting piece 65, the first stopper 105 and the second mounting piece 66 and the second stopper 106

States in which the movable shade 6 is positioned in the first location are the state as indicated by the solid line in FIG. 1 and the state as shown in FIG. 4, FIG. 6, and FIG. 7(A) That is, by way of the front side stopper 12, rotation in the front side direction of the movable shade 6 is stopped, and owing to the abutment between the first mounting piece 65 and the first stopper 105, movement in the right side axis direction of the movable shade 6 is stopped

States in which the movable shade 6 is positioned in the second location are the state as indicated by the dashed line in FIG. 1 and the state as shown in FIG. 7(B) That is, by the rear side stopper, rotation in the rear side direction of the movable shade 6 is stopped, and owing to the abutment between the second mounting piece 66 and the second stopper 106, movement in the left side axis direction of the movable shade 6 is stopped

When the movable shade 6 is positioned in the first location, the light from the semiconductor-type light source 2, the reflection light from the reflector 3 is optically controlled to a predetermined light distribution, that is, the low beam light distribution pattern When the movable shade 6 is positioned in the second location, the light from the semiconductor-type light source 2, the reflection light from the reflector 3 is optically controlled to a predetermined light distribution, that is, the high beam light distribution pattern

At the movable shade 6 and the bracket 10, a spring member 68 to bias the movable shade 6 in a forward direction about the central axis O is provided The spring member 68 is a torsional coil spring The spring member 68 is engaged with the rotating shaft 109 from the outside One arm of the spring member 68 is engaged with an edge of the engagement recessed section of the engagement piece 107 of the bracket 10 The other arm of the spring member 68 is engaged with an edge of an engagement hole 67 which is provided in the first shade 61

At a substantial center (middle) of a lower end part of the first shade 61, an engagingly locking piece 63 is integrally provided while the engagingly locking piece is bent at a right angle or substantially right angle to a rear side from the first shade 61 The engagingly locking piece 63 is parallel to or is substantially parallel to the first mounting piece 65 and the second mounting piece 66 In the engagingly locking piece 63, an engagingly locking hole 64 is provided Into the engagingly locking piece 64, a first arm 81 of the connecting member 8 is inserted

(Description of the Processing Steps (Manufacturing Steps) of First Shade 61)

Hereinafter, the manufacturing steps of the first shade 61 will be described with reference to FIG. 2 and FIG. 3 First, a stainless steel plate 610 which is an element material for the shade 61 is punched in accordance with a shape of the first shade 61 before bent In respect of the punched stainless steel plate 610, the through hole 60 is drilled by a first tool (jig) 91 (refer to FIG. 2(A), FIG. 2(B), FIG. 3(A), and FIG. 3(B)) Incidentally, punching of the stainless steel plate 610 and drilling of the through hole 60 may be carried out at the same time

A direction in which the through hole 60 is to be drilled is from a front face side (a front side or a topside) to a rear face side (a back face or a backside) of the stainless steel plate 610 (the first shade 61) Thus, a burring 600 is formed at an edge at the rear face side of the through hole 60 of the stainless steel plate 610 On the other hand, a droop 601 is formed at an edge at a front face side of the through hole 60 of the stainless steel plate 610

Next, the stainless steel plate 610 in which drilling of the through hole 60 has been carried out is crushed by a second tool (jig) 92 (refer to FIG. 2(B), FIG. 2(C), FIG. 3(B), and FIG. 3(C)) By way of such crushing, at an edge section at the burring 600 side of the through hole 60 of the stainless steel plate 610, a crushed surface 602 on which the burring 600 is crushed from an inner circumferential face of the through hole 60 of the stainless steel plate 610 to the inside (the first mounting piece 65 or the second mounting piece 66 side of the first shade 61) is formed The crushed surface 602, in this example, forms a shape of a side face of a truncated cone

A direction in which the crushed surface 602 is to be crushed is from a rear face side to a front face side of the stainless steel plate 610 (the first shade 61) Thus, the burring 600 at an edge at the rear face side of the through hole 60 of the stainless steel plate 610 is crushed to the inside, and the crushed surface 602 is formed

In addition, both of the left and right sides of the stainless steel plate 610 that has been crushed are bent In this manner, the first shade 61 is processed (manufactured) from the stainless steel plate 610

(Description of Solenoid 7)

The solenoid 7 is provided with a casing 70 which is mounted to a face at a front side of the bracket 10 Incidentally, in the solenoid 7, there may be a case in which a part of the bracket 10 is employed as a part of the casing 70

In the casing 70, a coil or the like (not shown) is housed On a side face at the left side of the casing 70, a plunger 71 as a driving section is mounted in a retractable manner The plunger 71 forms a columnar shape The advancement and retraction direction of the plunger 71 is orthogonal to or substantially orthogonal to the optical axis Z, and is parallel to or substantially parallel to the central axis O At a tip end part of the plunger 71, an annular engagingly locking groove 72 is provided At an edge of the engagingly locking groove 72, a second arm 82 of the connecting member 8 is engagingly locked

The solenoid 7 is intended to switch the movable shade 6 that is positioned in the first location to the second location and then switch light from the low beam light distribution to the high beam light distribution pattern by a driving force at the time of retraction of the plunger 71

(Description of Connecting Member 8)

The connecting member 8 is composed of a link member or a lever member The connecting member 8 has the mounting section 80 that is formed in a shape of a coil at a substantial center thereof The mounting section 80 is mounted to the mounting shaft 104 of the bracket 10 by way of the stop ring 83 The arm 81 at one side of the mounting section 80 is engagingly locked with an edge of the engagingly locking hole 64 of the movable shade 6 The second arm 82 at the other side of the mounting section 80 is engagingly locked with an edge of the engagingly locking groove 72 of the solenoid 7

### Description of Functions of First Embodiment

The vehicle lighting fixture 1 in the first embodiment is made of the constituent elements as described above, and hereinafter, functions thereof will be described

In a normal state, that is, when power is not supplied to the coil of the solenoid 7, the plunger 71 of the solenoid 7 is established in an advanced state (the stretched state as shown in FIG. 4 to FIG. 6) by a spring force of the spring member 68 At this time, at the first arm 81 of the connecting member 8, a force in the counterclockwise direction acts on the periphery of the mounting shaft 104 in the front view of FIG. 6 Thus, the force in the counterclockwise direction acts on an edge of the engagingly locking hole 64 of the engagingly locking piece 63 of the movable shade 6 with which the first arm 81 is engagingly locked The force in the counterclockwise direction is divided into a first divisional force oriented downward and a second divisional force oriented rightward

The first divisional force oriented downward acts on the movable shade 6 as a force of rotating the movable shade 6 in a front side direction about the central axis O (refer to the solid arrow in FIG. 1) This movable shade 6 is established in the state as indicated by the solid arrow in FIG. 1 while rotation in the front side direction is stopped by way of action of the front side stopper 12 On the other hand, the second divisional force oriented rightward acts on the movable shade 6 as a force of moving the movable shade 6 in the right side direction along the central axis O (refer to the arrow R in FIG. 7(A)) This movable shade 6 is established in the state as shown in FIG. 7(A) owing to the abutment between the first mounting piece 65 and the first stopper 105 That is, as shown in FIG. 7(A), a gap S (refer to FIG. 8(A)) is provided between the second mounting piece 66 and the second stopper 106, whereas no gap is provided between the first mounting piece 65 and the first stopper 105 As a result, the movable shade 6 is positioned in the first location without any backlash Incidentally, a gap may be provided between the first mounting piece 65 and the first stopper 105

When this state is established, the light emitting section 20 of the semiconductor-type light source 2 is lit and then is caused to emit light Afterwards, the light radiated from the light emitting section 20 oriented upward is reflected to the projection lens 4 side as reflection light by the reflection surface 30 of the reflector 3 Here, a part of the reflection light is shaded by the movable shade 6 that is positioned in the first location The reflection light that has not been shaded by the movable shade 6 that is positioned in the first location advances to the projection lens 4 side The reflection light that has advanced to the projection lens 4 side is incident into the projection lens 4 from the incidence surface 40 of the projection lens 4, and then, as a low beam light distribution pattern, the incident light is radiated from the emission surface 41 of the projection lens 4 to the outside, that is, to the front side of the vehicle

In a state in which the light emitting section 20 of the semiconductor-type light source 2 is lit and then is caused to emit light, power is supplied to the coil of the solenoid 7 Afterwards, the plunger 71 of the solenoid 7 retracts from the advanced state (stretched state) against the spring force of the spring member 68 Concurrently with the retraction of the plunger 71, at the first arm 81 of the connecting member 8, a force in the clockwise direction acts on the periphery of the mounting shaft 104 in the front view of FIG. 6 Thus, the force in the clockwise direction acts on the edge of the engagingly locking hole 64 of the engagingly locking piece 63 of the movable shade 6 with which the first arm 81 is engagingly locked The force in the clockwise direction is divided into a first divisional force oriented upward and a second divisional force oriented leftward

The first divisional force oriented upward acts on the movable shade 6 as a function of rotating the movable shade 6 in a rear side direction about the central axis O (refer to the dashed arrow in FIG. 1) This movable shade 6 is established in the state as indicated by the dashed line in FIG. 1 while rotation in the rear side direction is stopped by way of action of the rear side stopper On the other hand, the second divisional force oriented leftward acts on the movable shade 6 as a force of moving the movable shade 6 in a left side direction along the central axis O (refer to the arrow L in FIG. 7(B)) This movable shade 6 is established in the state shown in FIG. 7(B) owing to the abutment between the second mounting piece 66 and the second stopper 106 That is, as shown in FIG. 7(B), a gap is provided between the first mounting piece 65 and the first stopper 105, whereas no gap is provided between the second mounting piece 66 and the second stopper 106 (refer to FIG. 8(B)). As a result, the movable shade 6 is positioned in the second location without any backlash Incidentally, a gap may be provided between the second mounting piece 66 and the second stopper 106

At this time, a part of the reflection light that has been shaded so far by the movable shade 6 that is positioned in the first location is not shaded by the movable shade 6 that is positioned in the second location, but advances to the projection lens 4 side together with the reflection light that has not been shaded by the movable shade 6 that is positioned in the first location The reflection light that has advanced to the projection lens 4 side is incident into the projection lens 4 from the incidence surface 40 of the projection lens 4, and then, as a high beam distribution pattern, the incident light is radiated from the emission surface 41 of the projection lens 4 to the outside, that is, the front side of the vehicle.

Then, power supply to the coil of the solenoid 7 is interrupted. Afterwards, the plunger 71 of the solenoid 7 is advanced from its retracted state by the spring force of the spring member 68 In this manner, as described previously, the movable shade 6 is positioned in the first location without any backlash. Subsequently, a low beam light distribution pattern is radiated from the emission surface 41 of the projection lens 4 to the outside, that is, the front side of the vehicle.

### Description of Advantageous Effects of First Embodiment

The vehicle lighting fixture 1 in the first embodiment is made of the constituent elements and functions as described above, and hereinafter, advantageous effects thereof will be described.

The vehicle lighting fixture 1 in the first embodiment forms the crushed surface 602 at least at one of the edge sections of the through holes 60 of the first mounting piece 65 and the second mounting piece 66 of the first shade 61 that is composed of the stainless steel plate 610 to be thus able to eliminate the burring 60 that is prone to arise at the edge of the through hole 60 of the first mounting piece 65 or the second mounting piece 66 of the first shade 61 Therefore, according to the vehicle lighting fixture 1 in the first embodiment, the surface of the rotating shaft 109 is not damaged owing. to the burring 600 over a long period of time, thus making it possible to achieve smooth switching of light distribution

In so far as the vehicle lighting fixture 1 in the first embodiment is concerned, the rotating shaft 109 is composed of the stainless steel, and the first shade 61 is composed of the stainless steel plate 610 Therefore, according to the vehicle light fixture 1 in the first embodiment, surface treatment of the rotating shaft 109 and the first shade 61 can be eliminated; and hence, manufacturing is simplified, and manufacturing costs are reduced.

Here, in a case where the rotating shaft 109 is composed of the stainless steel and the first shade 61 is composed of the stainless steel plate 610, if the present invention is not carried out, the surface of the rotating shaft 109 is prone to be damaged owing to the burring 600 On the contrary to this, the vehicle lighting fixture 1 in the first embodiment eliminates the burring 600; and therefore, even in the case where the rotating shaft 109 is composed of the stainless steel and the first shade 61 is composed of the stainless steel plate 610, the surface of the rotating shaft 109 is not damaged owing to the burring 600

According to the vehicle lighting fixture 1 in the first embodiment, drilling and crushing of the through hole 60 are carried out and thus processing (manufacturing) is simplified, and manufacturing costs can be reduced

In so far as the vehicle lighting fixture 1 in the first embodiment is concerned, the movable shade 6 is movable with respect to the rotating shaft 109, in the direction of the central axis O of the rotating shaft 109; the first mounting piece 65 and the second mounting piece 66 of the movable shade 6 are orthogonal to or substantially orthogonal to the direction of the central axis O; and at the bracket 10, the first stopper 105 and the second stopper 106 that respectively abut against the first mounting piece 65 and the second mounting piece 66 to stop movement in the direction of the central axis O of the movable shade 6 are provided Therefore, the vehicle lighting fixture 1 in the first embodiment is capable of positioning the movable shade 6 in the first location and the second location without any backlash In this manner, it is possible to obtain a low beam light distribution pattern and a high beam light distribution pattern with a high precision

In so far as the vehicle lighting fixture 1 in the first embodiment is concerned, the face at the droop 601 side of the respective one of the first mounting piece 65 and the second mounting piece 66 and the face at the droop 111 side of the respective one of the first stopper 105 and the second stopper 106 oppose to each other Thus, according to the vehicle lighting fixture 1 in the first embodiment, even if the first mounting piece 65 or the second mounting piece 66 and the first stopper 105 or the second stopper 106 abut against each other, they are not damaged owing to the burring (600), 110 In addition, even in a case where the face at the crushed surface 602 side of the respective one of the first mounting piece 65 and the second mounting piece 66 and the face at the droop 111 side of the respective one of the first stopper 105 and the second stopper 106 oppose to each other, they are not damaged as described previously

In so far as the vehicle lighting fixture 1 in the first embodiment is concerned, the face at the droop 601 side of the respective one of the first mounting piece 65 and the second mounting piece 66 or the face at the crushed surface 602 side and the face at the droop 111 side of the respective one of the first stopper 105 and the second stopper 106 oppose to each other Therefore, according to the vehicle lighting fixture 1 in the first embodiment, no small irregularities such as burring are provided between the first mounting piece 65, the second mounting piece 66 and the first stopper 105, the second stopper 106; and hence, the movable shade 6 can be positioned in the first location and the second location with a high precision

### Description of Configuration, Functions, and Advantageous Effects of Second Embodiment

FIG. 9 and FIG. 10 each show a second embodiment of the vehicle lighting fixture according to the present invention Hereinafter, a configuration, functions, and advantageous effects of the vehicle lighting fixture according to the second embodiment will be described In the figures, the same constituent elements are respectively designated by the same reference numerals in FIG. 1 to FIG. 8

In so far as the vehicle lighting fixture according to the second embodiment, as shown in FIG. 9 and FIG. 10, is concerned, the processing steps (the manufacturing steps) of the first shade 608 are different from the processing steps (the manufacturing steps) of the first shade 61 of the vehicle lighting fixture 1 according to the first embodiment

Hereinafter, the manufacturing steps of the first shade 608 will be described with reference to FIG. 9 and FIG. 10 First, the stainless steel plate 610 that is an element material for the first shade 608 is punched in accordance with a shape of the first shade 608 before bent In the stainless steel plate 610 that has been punched, a lower hole 603 is drilled by a first tool (jig) 901 (refer to FIG. 9(A), FIG. 9(B), FIG. 10(A), and FIG. 10(B)) Incidentally, punching of the stainless steel plate 610 and drilling of the lower hole 603 may be carried out at the same time

A direction in which the lower hole 603 is to be drilled is from a front face side (a front side, a topside) to a rear face side (a back face, a backside) of the stainless steel plate 610 (the first shade 608) Thus, burring 604 is formed at an edge of a rear face side of the lower hole 603 of the stainless steel plate 610 On the other hand, a droop 605 is formed at an edge of a front face side of the lower hole 603 of the stainless steel plate 61

Next, in the stainless steel plate 610 in which the lower hole 603 has been drilled, burring processing is carried out by a second tool (jig) 902 (refer to FIG. 9(B), FIG. 9(C), FIG. 10(B), and FIG. 10(C)) By such burring processing, a through hole 606 is drilled from the lower hole 603 of the stainless steel plate 610 An inner circumferential face of this through hole 606 is a surface of the stainless steel plate 610 and thus becomes a smooth face

A direction in which the through hole 606 is to be drilled is from a front face side to a rear face side of the stainless steel plate 610 (first shade 608) Thus, at one edge of the through hole 606 of the stainless steel plate 610 (the edge at the burring 604 side of the lower hole 603), in this example, a cylindrical or substantially cylindrical flange 609 is formed Incidentally, at the other edge of the through hole 606 of the stainless steel plate 610 (the edge at the droop 605 side of the lower hole 603), a droop which is larger than the droop 605 of the lower hole 603 is formed In addition, there may be a case in which the burring 604 of the lower hole 603 still remains at an outside edge of the flange 609

Afterwards, the stainless steel plate 610 for which burring processing has been carried out is pressed by a third tool (jig) 903 (refer to FIG. 9(C), FIG. 9(D), FIG. 10(C), and FIG. 10(D)) At the flange 609 of the stainless steel plate 610 that has been formed by pressing, a pressed surface 607 in which opening of the flange 609 is pressed from the inner circumferential face of the flange 609 to the outside is formed

A pressing direction is from the rear face side to the front face side of the stainless steel plate 610 (first shade 608) Thus, the pressed surface 607 is formed at the flange 609 of the stainless steel plate 610 This pressed surface 607, in this example, forms a shape of a side face of a truncated cone In addition, the outside edge of the flange 609 is positioned at the outside from the inner circumferential face of the through hole 606 more significantly in comparison with the outside edge of the flange 609 before pressed Thus, the remaining burring 604 of the lower hole 603 can be positioned at the outside from the inner circumferential face of the through hole 606

Afterwards, the stainless steel plate 610 that has been pressed is bent at both of the left and right side thereof In this manner, a first shade 608 is processed (manufactured) from the stainless steel plate 610

The vehicle lighting fixture according to the second embodiment is capable of achieving functions and advantageous effects which are substantially similar to those of the vehicle lighting fixture 1 according to the first embodiment In particular, in the vehicle lighting fixture according to the second embodiment, the through hole 606 is formed by burring processing; and therefore, the inner circumferential face of the through hole 606 is the surface of the stainless steel plate 610 and thus becomes a smooth face In this manner, the vehicle lighting fixture according to the second embodiment is capable of reliably protecting the surface of the rotating shaft 109 from damage

Moreover, the vehicle lighting fixture according to the second embodiment forms the pressed surface 607 at the flange 609 that has been formed by burring processing Thus, the remaining burring 604 of the lower hole 603 can be positioned at the outside from the inner circumferential face of the through hole 606 In this manner, the vehicle lighting fixture according to the second embodiment is capable of reliably protecting the surface of the rotating shaft 109 from damage

In the vehicle lighting fixture according to the second embodiment, it is preferable that the face at the droop 605 side of the respective one of the first mounting piece 65 and the second mounting piece 66 and the face at the droop 111 side of the respective one of the first stopper 105 and the second stopper 106 oppose to each other Incidentally, the opposite faces of the first mounting piece 65 and the second mounting piece 66 and the first stopper 105 and the second stopper 106 may be those other than the above ones

### Description of Examples Other Than First and Second Embodiments

Incidentally, in the first and second embodiments, the movable shade 6 was mounted to the bracket 10 so as to be switchable between the first location and the second location However, in the present invention, the movable shade 6 may be mounted to a certain mounting member other than the bracket 10 so as to be switchable between the first location and the second location

In addition, in the first and second embodiments, the semiconductor-type light source 2 was used as a light source However, in the present invention, as a light source, there may be a certain light source other than the semiconductor-type light source 2, for example, a discharge lamp light source, a halogen lamp light source, an incandescent lamp light source, a laser device to emit laser light or the like

Further, the first and second embodiments were described with respect to the vehicle lighting fixture of projector type that is composed of; the reflector 3 having the reflection surface 30 on the basis of an ellipse; and the projection lens 4 However, in the present invention, there may be a certain vehicle lighting fixture other than the vehicle lighting fixture of projector type, for example, a vehicle lighting fixture of lens direct emission type or a vehicle lighting fixture of reflection type or the like

Furthermore, in the first and second embodiments, the movable shade 6 was used as a movable, optical controlling member for light distribution However, in the present invention, as a movable, optical controlling member for light distribution, there may be a certain movable, optical controlling member other than the movable shade 6, for example, a lens member to vary an optical path (orientation) of light distribution or to diffuse or focus (converge) light distribution, or alternatively, a filter member or the like to transmit or shade light of a specific wavelength

Still furthermore, in the first and second embodiments, the solenoid 7 was used as a driving mechanism However, in the present invention, as a driving mechanism, there may be a certain driving mechanism other than the solenoid 7, for example, a motor or the like A driving section in the case of this motor is employed as an output shaft

Yet furthermore, in the first and second embodiments, the rotating shaft 109 was composed of the stainless steel, and the first shades 61, 608 were composed of the stainless steel plate 610 However, in the present invention, the rotating shaft 109 and the first shades 61, 608 may be made of a certain kind of steel or steel plate other than the stainless steel and the stainless steel plate 610, for example, a cold rolled steel plate and a steel belt

Furthermore, in the first embodiment, the face at the droop 61 side of the respective one of the first mounting piece 65 and the second mounting piece 66 opposed to the face at the droop 111 side of the respective one of the first stopper 105 and the second stopper 106 However, in the present invention, the face at the crushed surface 602 side of the respective one of the first mounting piece 65 and the second mounting piece 66 may oppose to the face at the droop 111 side of the respective one of the first stopper 105 and the second stopper 106

Still furthermore, in the second embodiment, the pressed surface 607 was formed at the flange 609 that had been formed by burring processing However, in the present invention, pressing may be omitted while only burring processing is carried out

### DESCRIPTION OF REFERENCE NUMERALS

1 Vehicle lighting fixture
10 Bracket (mounting member)
11 Holder (mounting member)
12 Front side stopper
100 Recessed section
101 First plate section
102 Second plate section
103 Third plate section
104 Mounting shaft
105 First stopper
106 Second stopper
107 Engagement piece
108 Swaging piece
109 Rotating shaft
110 Burring
111 Droop
2 Semiconductor-type light source (light source)
20 Light emitting section
21 Holder
3 Reflector
30 Reflection surface
4 Projection lens
40 Incidence surface
41 Emission surface
5 Heat sink member
50 Top plate section
52 Fin section
6 Movable shade (movable, optical controlling member for light distribution)
60 Through hole
61 First shade
62 Second shade
63 Engagingly locking piece
64 Engagingly locking hole
65 First mounting hole
66 Second mounting hole
67 Engagement hole
68 Spring member
600 Burring
601 Droop
602 Crushed surface
603 Lower hole
604 Burring
605 Droop
606 Through hole
607 Pressed surface
608 First shade
609 Flange
610 Stainless steel plate
7 Solenoid (driving mechanism)
70 Casing
71 Plunger
72 Engagingly locking groove
8 Connecting member (driving mechanism)
80 Mounting section
81 First arm
82 Second arm
83 Stop ring
9 Optical control device for light distribution
91 First tool (jig)
92 Second tool (jig)
901 First tool (jig)
902 Second tool (jig)
903 Third tool (jig)
B Back
D Downside
F Front
F1 First focal point
F2 Second focal point
F3 Focal point
L Left
O Central axis
R Right
S Gap
U Upside
Z Optical axis

1. A vehicle lighting fixture comprising a light source and an optical control device for light distribution, which optically controls light from the light source to a predetermined light distribution, wherein
the optical control device for light distribution has:
a bracket;
a movable, optical controlling member for light distribution, which is mounted to the bracket so as to be rotatable via a rotating shaft; and
a driving mechanism to rotate the movable, optical controlling member for light distribution,
the movable, optical controlling member for light distribution is composed of a plate material,
at the movable, optical controlling member for light distribution, a mounting member is provided,
at the mounting piece, a through hole into which the rotating shaft is to be inserted is provided, and
at least at an edge section of the through hole, a crushed surface, which is crushed at the mounting piece side from an inner circumferential face of the through hole, is formed

2. The vehicle lighting fixture according to claim 1, wherein
the movable, optical controlling member for light distribution is movable along the rotating shaft with respect to the rotating shaft,
the mounting piece of the movable, optical control members for light distribution is orthogonal to or substantially orthogonal to a direction of a central axis thereof, and
at the bracket, a stopper to abut against the mounting piece to thereby stop movement in the direction of the central axis of the movable, optical controlling member for light distribution is provided

3. A vehicle lighting fixture comprising a light source and an optical control device for light distribution, which optically controls light from the light source to a predetermined light distribution, wherein
the optical control device for light distribution has:
a bracket;
a movable, optical controlling member for light distribution, which is mounted to the bracket so as to be rotatable via a rotating shaft; and
a driving mechanism to rotate the movable, optical controlling member for light distribution,
the movable, optical controlling member for light distribution is composed of a plate material;
at the movable, optical controlling member for light distribution, a mounting member is provided, and
in the mounting piece, a through hole into which the rotating shaft is to be inserted is provided by burring processing

4. The vehicle lighting fixture according to claim 3, wherein
at one edge of the through hole, a cylindrical flange is formed by the burring processing, and
at the flange, a pressed surface on which opening of the flange is pressed from an inner circumferential face of the flange to an outside is formed

5. The vehicle lighting fixture according to claim 3, wherein
the movable, optical controlling member for light distribution is movable with respect to the rotating shaft, in the direction of the central axis of the rotating shaft,
the mounting piece of the movable, optical controlling member for light distribution is orthogonal to or substantially orthogonal to the direction of the central axis, and
at the bracket, a stopper to abut against the mounting piece to thereby stop movement in the direction of the central axis of the movable, optical controlling member for light distribution is provided

6. The vehicle lighting fixture according to claim 4, wherein
the movable, optical controlling member for light distribution is movable with respect to the rotating shaft, in the direction of the central axis of the rotating shaft,
the mounting piece of the movable, optical controlling member for light distribution is orthogonal to or substantially orthogonal to the direction of the central axis, and
at the bracket, a stopper to abut against the mounting piece to thereby stop movement in the direction of the central axis of the movable, optical controlling member for light distribution is provided
